(19) United States
(12) Patent Application Publication
(10) Pub. No.: US 2015/0053795 A1
(43) Pub. Date: Feb. 26, 2015

(54) CERAMIC PROTECTION FOR FUEL INJECTOR LINES

(71) Applicant: Walbar Inc, Peabody, MA (US)

(72) Inventor: Sandy Spoone, Greenwood, SC (US)

(73) Assignee: WALBAR INC, Peabody, MA (US)

(21) Appl. No.: 14/167,022

(22) Filed: Jan. 29, 2014

Related U.S. Application Data
(60) Provisional application No. 61/868,241, filed on Aug. 21, 2013.

(51) Int. Cl. F02M 53/04; B32B 37/12; B32B 37/14; F02M 61/16

(52) U.S. Cl. CPC F02M 53/046; F02M 61/166; B32B 37/12; B32B 37/142
USPC 239/584; 156/293

(57) ABSTRACT

A fuel injector body comprising a fuel line defined by a passage therethrough and a ceramic cylinder disposed within the passage. The ceramic cylinder is a tube including a hollow passage for fuel flow therethrough. In addition, a method of protecting the fuel lines of a fuel injector is disclosed, comprising the steps of inserting a ceramic cylinder into at least passage for a fuel line of the fuel injector and adhering the ceramic cylinder within the passage.

### CROSS-REFERENCE TO RELATED APPLICATIONS

This application claims the benefit of and priority to U.S. Provisional Patent Application No. 61/868,241 filed Aug. 21, 2013, which is incorporated by reference herein in its entirety.

### BACKGROUND OF THE INVENTION

1. Field of the Invention

The present disclosure relates to fuel injectors, and more particularly to fuel injectors for use in internal combustion, for example.

2. Description of Related Art

Fuel injectors used in internal combustion engines are subjected to relatively high operating temperatures. When exposed to relatively high temperatures the fuel injectors can experience pre-ignition. Pre-ignition describes the event wherein the air/fuel mixture in the fuel injector ignites before it is intended to do so. Pre-ignition is initiated by an unintended ignition source, such as hot spots in the combustion chamber, a spark plug that runs too hot for the application, or carbonaceous deposits in the combustion chamber heated to incandescence by previous engine combustion events.

To prevent pre-ignition manufacturers are looking at thermal barrier coating in fuel injectors. The thermal barrier coating is made of ceramic and sprayed by a robotic spray process.

However, while the spraying of the thermal barrier coating into the fuel lines is one useful solution, when the fuel lines are smaller in diameter and/or the nozzle of the spray cannot reach the fuel line to apply the barrier coating, another solution is required.

There is still a need in the art for apparatus and methods that allow for an improved fuel injector having ceramic coated fuel lines. There also remains a need in the art for such methods and devices that are easy to make and use. The present disclosure provides a solution for these problems.

### SUMMARY OF THE INVENTION

A fuel injector body having a fuel line defined by a passage therethrough and a ceramic cylinder disposed within the passage. It is contemplated that the feed arm can include a plurality of passages such that at least one passage includes the ceramic cylinder disposed therein.

The ceramic cylinder is a tube including a hollow passage for fuel flow therethrough. The ceramic cylinder can extend the length of the passage.

A lip can surround an opening downstream of the passage configured to act as a stop for the ceramic cylinder. The passage can be 0.113 inches in diameter for accommodating adequate wall thickness of the ceramic cylinder.

The ceramic cylinder can be adhered within the passage. In certain embodiments the ceramic cylinder is adhered using Araldite™ 2011. In an alternate embodiment, the ceramic cylinder is adhered using Duralco™ 4525.

A method of protecting the fuel line of a fuel injector includes inserting a ceramic cylinder into at least one passage for a fuel line of the fuel injector and adhering the ceramic cylinder within the passage. The step of adhering can further include adhering an outer surface of the ceramic cylinder to an inner surface of the passage.

These and other features of the systems and methods of the subject disclosure will become more readily apparent to those skilled in the art from the following detailed description of the preferred embodiments taken in conjunction with the drawings.

### BRIEF DESCRIPTION OF THE DRAWINGS

So that those skilled in the art to which the subject disclosure appertains will readily understand how to make and use the devices and methods of the subject disclosure without undue experimentation, preferred embodiments thereof will be described in detail herein below with reference to certain figures, wherein:

FIG. 1 is a perspective view of a fuel injector constructed in accordance with the present disclosure showing a ceramic cylinder being inserted into one of the passages;

FIG. 2 is a perspective view of a downstream end of the feed arm of FIG. 1, showing a ceramic cylinder disposed therein; and

FIG. 3 is an end view of a fuel injector of FIG. 1 illustrating a lip added to further secure the ceramic cylinder.

### DETAILED DESCRIPTION OF THE PREFERRED EMBODIMENTS

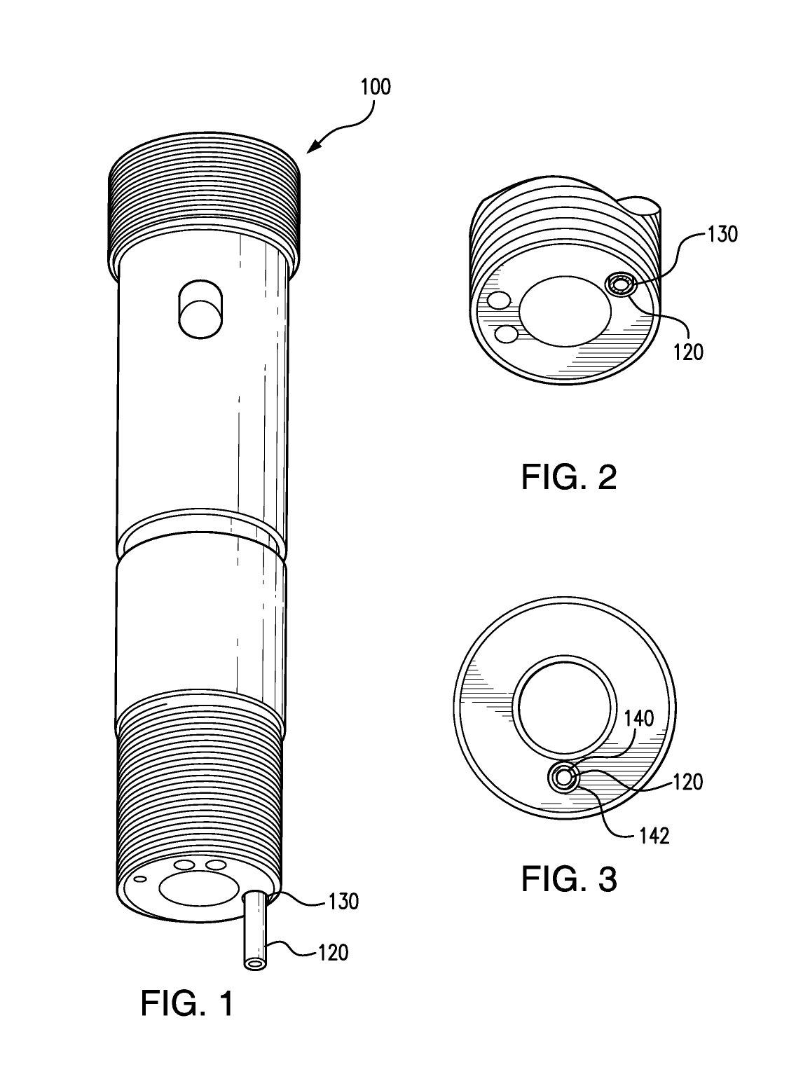

Reference will now be made to the drawings wherein like reference numerals identify similar structural features or aspects of the subject disclosure. For purposes of explanation and illustration, and not limitation, a partial view of an exemplary embodiment of a feed arm of a fuel injector in accordance with the disclosure is shown in FIG. 1 and is designated generally by reference character 100. The systems and methods described herein can be used to prevent pre-ignition in fuel injectors.

FIG. 1 illustrates a fuel injector 100 used in a typical internal combustion engine. In general, fuel injectors are subjected to relatively high temperatures during use. The relatively high temperatures can in turn cause pre-ignition of the fuel injectors. To prevent pre-ignition, thermal barrier coatings made of ceramic are needed to coat the fuel lines and temper the conditions which may cause pre-ignition. However, in some instances the nozzle of the spray for the thermal barrier coatings is unable to reach the fuel lines to be coated. One such fuel line wherein the spray for the thermal barrier coating cannot reach the fuel lines is the P11 series fuel injector made by Transonic Combustion™ of Camarillo, Calif.

An exemplary embodiment of the present invention is shown in FIGS. 1 and 2 wherein a ceramic cylinder 120 is disposed within a fuel line in the form of a passage 130 to prevent pre-ignition. The ceramic cylinder 120 is adhered to the passage 130 to secure the ceramic cylinder 120 in place. The ceramic cylinder 120 is a tube which allows fluid to flow therethrough so as not to interrupt the passage 130 injecting fuel from the fuel injector. (Inventor: does CoorsTek or anyone else provide a commercial product that can be used as the ceramic cylinder 130?). The ceramic cylinder preferably extends the length of the passage so as to prevent the fuel injector from pre-ignition. As shown in FIG. 2, one passage 130 includes the ceramic cylinder 120 disposed therein, however it is understood that a fuel injector including a plurality of passages can include ceramic cylinders in one or more of the fuel lines.

The ceramic cylinder 120 is adhered within the passage 130 using an adhesive such as Araldite™ 2011, a structural epoxy that is a registered trademark of Huntsman Advanced Materials of Bergkamen, Germany, or Duralco™ 4525, a registered trademark of Cotronics Corporation of Brooklyn, N.Y. The adhesive may be disposed between an outside surface of the ceramic cylinder and an inner surface of the passage.

With reference to FIG. 3, in addition to the ceramic cylinder 120 disposed within the fuel line, a lip 140 is constructed surrounding an opening 142 downstream of the passage 130. The lip 140 is an inwardly extending portion of the opening 142 that acts as a stop for the ceramic cylinder 130. The fuel injector 100 can be made of stainless steel and can be placed in an oven at 400° F. to simulate the operating temperature. The ceramic cylinders can also be pressed to withstand a 500 lb force.

Due to the tolerance band on the ceramic cylinder of +/−0.0762 mm (0.003 inches) and thin cylinder wall of 0.432 mm (0.017 inches), it is contemplated that the passage is expanded to 2.87 mm (0.113 inches) in diameter to account for cylinder variation and provide an adequate wall thickness of the ceramic cylinder.

A method of protecting the fuel lines of a fuel injector is also disclosed. A ceramic cylinder, e.g., cylinder 120, is inserted into at least one passage, e.g., passage 130, of a fuel injector and adhered within the passage. The step of adhering further can include adhering an outer surface of the ceramic cylinder to an inner surface of the passage.

The methods and systems of the present disclosure, as described above and shown in the drawings, provide for feed arm of a fuel injector with superior properties including a reduction or prevention of pre-ignition. While the apparatus and methods of the subject disclosure have been shown and described with reference to preferred embodiments, those skilled in the art will readily appreciate that changes and/or modifications may be made thereto without departing from the spirit and scope of the subject disclosure.

What is claimed is:

1. A fuel injector body comprising:
a fuel line defined by a passage therethrough; and
a ceramic cylinder disposed within the passage.

2. The fuel injector as recited in claim 1, wherein the ceramic cylinder is a tube including a hollow passage for fuel flow therethrough.

3. The fuel injector as recited in claim 2, wherein the ceramic cylinder extends the length of the passage.

4. The fuel injector as recited in claim 2, wherein a lip surrounds an opening downstream of the passage configured to act as a stop for the ceramic cylinder.

5. The fuel injector as recited in claim 2, wherein the passage is 0.113 inches in diameter for accommodating adequate wall thickness of the ceramic cylinder.

6. The fuel injector as recited in claim 2, wherein the ceramic cylinder is adhered within the passage.

7. The fuel injector as recited in claim 6, wherein the ceramic cylinder is adhered using Araldite 2011.

8. The fuel injector as recited in claim 6, wherein the ceramic cylinder is adhered using Duralco™4525.

9. The fuel injector as recited in claim 2, wherein the fuel injector includes a plurality of passages such that at least one passage includes the ceramic cylinder disposed therein.

10. A fuel injector for an internal combustion engine comprising:
a plurality of fuel lines defining a plurality of passages, each passage having a ceramic cylinder disposed therein, wherein the ceramic cylinder is adhered within the passage, each passage having a lip that surrounds the opening downstream of the passage.

11. The fuel injector as recited in claim 10, wherein the ceramic cylinder is a tube including a hollow passage for fuel flow therethrough.

12. The fuel injector as recited in claim 11, wherein the ceramic cylinder extends the length of the at least one passage.

13. The fuel injector as recited in claim 11, wherein the at least one passage is 0.113 inches in diameter for accommodating adequate wall thickness of the ceramic cylinder.

14. The fuel injector as recited in claim 11, wherein the ceramic cylinder is adhered using Araldite™2011.

15. The fuel injector as recited in claim 11, wherein the ceramic cylinder is adhered using Duralco™4525.

16. A method of protecting the fuel lines of a fuel injector comprising the steps of:
inserting a ceramic cylinder into at least passage for a fuel line of the fuel injector, wherein the ceramic cylinder is a tube including a hollow passage for fuel flow therethrough; and
adhering the ceramic cylinder within the passage.

17. The method as recited in claim 16, wherein the step of adhering further includes adhering an outer surface of the ceramic cylinder to an inner surface of the passage.

18. The method as recited in claim 17, wherein the step of adhering includes using Araldite™ 2011.

19. The method as recited in claim 17, wherein the step of adhering includes using Duralco™ 4525.
